(19) United States
(12) Patent Application Publication
(10) Pub. No.: US 2001/0029463 A1
(43) Pub. Date: Oct. 11, 2001

(54) System and method for facilitating political advocacy

(76) Inventor: Patrick Neal Fuller, Baton Rouge, LA (US)

Correspondence Address: McDERMOTT, WILL & EMERY, 600 13th Street, N.W., Washington, DC, 20005-3096, US

(21) Appl. No.: 09/732,934

(22) Filed: Dec. 11, 2000

Related U.S. Application Data
(60) Provisional application No. 60/173,664, filed on Dec. 30, 1999.
(60) Provisional application No. 60/176,243, filed on Jan. 14, 2000.

(51) Int. Cl. G06F 17/60

(52) U.S. Cl. 705/12

(57) ABSTRACT

A method and system for political advocacy is described that uses a nationwide voter registration database, rather than a zip code-to-district matching system, to link advocates to their elected officials. Thus, advocates can contact the appropriate elected officials, and the elected officials can be informed of the advocates' political relevance. Furthermore, a targeted political advocacy technique is described in which a grassroots coordinator can send action alerts to those advocates who are registered to vote in districts of a particular group of legislators.

### FIELD OF INVENTION

The present application relates to political advocacy and more particularly to a system and method for facilitating political advocacy.

### BACKGROUND

Current methods of contacting one's elected officials through the internet to support or oppose legislation (called grassroots advocacy) are often inaccurate, open to fraud, or both. Although on-line grassroots advocacy has the potential to reinvigorate the political process by encouraging citizen participation, current practice is of limited worth both to the interest groups who generate these communications and the elected officials who receive them.

The process of grassroots political advocacy typically works as follows: a bill is introduced in a legislative body; interest groups or coalitions of such groups gravitate to opposing sides of the bill; the interest groups rally their members or (through mass media advertising) drum up support for their side in the general public; those interested in the issue are instructed to contact their legislators; they are then given direction on how to contact the legislator.

From this point the different methods of grassroots advocacy diverge. In the past, interest groups have called on their supporters to make phone calls and send letters by first-class mail or faxes to their elected officials. Recently, some groups have tried to use the medium of email for the same purposes, with some success.

The sticking point in the whole enterprise, however, is that most people, who would otherwise be willing to participate in such a wholesome democratic exercise, do not possess the names or the proper contact information for their elected officials. In order to find this information, they must look through legislative guides, and, more importantly, they must know their elected officials' names. Since most people don't have this kind of information handy, the effort curve is too high for many of these people to act.

To ameliorate this lack of information, numerous companies have recently created sites on the World Wide Web that provide the grassroots advocate with elected official contact information by linking that advocate's address (input through a web-based form) to a database containing the contact information of all federal and state elected officials. This is accomplished by crossing a zip code mapping database with a legislative district mapping database.

So, for example, an interest group running a grassroots advocacy campaign could advertise a website that provides this information to the uninformed advocate. That advocate could then simply go to the Web address, input his own zip code, and find all the contact information that he needs. The advocate would then be encouraged to send a message directly from the Web site to his elected officials using tools provided by the Web site (such as form letters, direct email or fax links, etc.).

Unfortunately, there are limitations to using the zip code-to-district technology described. Zip code boundaries and legislative district boundaries do not match up perfectly, and, as a result, the reports that are generated by these zip code based searches are often incorrect. In such a case, an advocate could send a message to an elected official other than the advocate's own. If the elected official's staff checks whether or not that person is registered in the official's district, and the staff does not find the person's name in their database, the message will most likely be ignored. Were this to happen, the group organizing the grassroots campaign would have wasted a great opportunity. So accuracy in determining elected official contact information is critical, but zip code-to-district matching services are inaccurate.

Another inadequacy in the prior art involves the inability to certify the political relevance of the advocate contacting the elected official. As used in this disclosure, “political relevance” refers to the elected official's recognition that the advocate in question can have an impact on that official's re-election. Most legislators are very concerned to listen to the concerns of their voting constituents (i.e. those citizens registered to vote in their districts). They are not nearly as concerned (if at all) about listening to the concerns of persons living outside of their districts or to persons not registered to vote. The elected official would also be interested to know, even if the advocate is registered to vote, how many times that advocate has voted in actual past elections. Since the zip code-to-district matching technology is geographically-focused, the prior art has no way of telling an elected official how politically relevant that particular advocate is.

Another inadequacy in the prior art involves the lack of fraud prevention measures. Elected officials are concerned about fraudulent messages being sent by interest groups bent on influencing legislation at any cost. Such an interest group could pay someone to churn out forged messages, ostensibly from people in the elected official's district. The interest group will then flood the legislative office with bogus messages, advising the legislator to vote for or against a certain bill. The legislator, thinking that these were authentic messages of his constituents, votes against a bill that the legislator would have otherwise voted for. In such a case, the legislator will have been misled and the process of representative democracy will have been adulterated. More important for the elected official than simply being misled, the official may face the wrath of registered voters in his district when those voters find out that the official voted against their true wishes.

This scenario amplifies the importance of implementing security measures when using the internet for grassroots advocacy. The zip code-to-district technology, in itself, cannot verify the identity of the person sending the message. This lack of security dilutes the impact of legitimate zip code based advocacy campaigns, giving all such campaigns a black eye.

A further inadequacy in the prior art concerns the inability of present systems to focus grassroots pressure on certain elected officials targeted by the interest group. At present, grassroots advocacy systems use what may be called the “shotgun approach” to internet advocacy. In such an approach, the interest group develops a web site and encourages all of the group's members to contact their elected officials. The problem with this is clear to anyone who knows how the public policy process works. Even before a bill is introduced a group may need to put pressure on a single lawmaker to encourage him to introduce such legislation or sign on as a cosponsor. Alternatively, the group might want to put pressure only on all members of one committee in the House of Representatives, since the bill may never make it to the fill House anyway, or the group might want to send a different message to swing votes in the Senate, to Democrats or to Republicans. The shotgun approach of the prior art does not allow an interest group to focus their grassroots advocates in these ways.

For all of the above reasons the prior art is therefore inadequate.

### SUMMARY OF INVENTION

Accordingly, there exists a need for facilitating on-line political advocacy while avoiding the inaccuracies of the prior art. There is also a need for more politically relevant information about each advocate. A need also exists for a more secure on-line political advocacy technology that is less susceptible to fraud and other abuses. Finally, there is a need for avoid the shotgun approach to political advocacy.

These and other needs are addressed by the present invention, which is voter-centric not geographic-centered. In particular, individual advocates are linked with a voter registration database. For example, an individual could provide his or her name, address, and date of birth. That personal information is looked up in the voter registration database to identify such information as whether the individual is registered to vote, which political and legislative districts the individual belongs to, how many times the individual has voted, and other politically relevant information.

Since the individual's legislative district can be accurately identified, the contact information for the correct legislator can be readily determined and the inaccuracies of the prior art in sending messages to the wrong (e.g. neighboring) legislator are resolved. Furthermore, since the voter registration database contains politically relevant information, that information can be passed along to the legislator for evaluation. In addition, fraud is reduced because the personal information needed to use the system is more difficult to obtain.

Accordingly, one aspect of the invention relates to a method, web site, and software for facilitating political advocacy on-line, in which personal information (such as name, address, and date of birth) is received that identifies an advocate. A voter database is accessed to retrieve voter information (such as voter registration, voter legislative district, and voting history) about the advocate based on the personal information, and a message is sent to a political official based on the voter information. The message can be automatically to include the voter information of the advocate so that the political official can assess the advocate's political relevance.

Another aspect of the invention pertains to a method, web site, and software for targeted political advocacy, a selection targeting one or more political officials is made. An advocate database including voter information is accessed to identify one or more advocates that are registered to vote in a corresponding voting district of the political officials, and an action alert is sent to the one or more identified advocates. Thus, instead of the shotgun approach of conventional message, the grassroots advocates of a targeted set of officials (e.g. members of a particular House committee) can be alerted to exercise their first amendment rights.

Still other objects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a computer system upon which an embodiment of the invention may be implemented.

FIG. 2A is a block diagram illustrating the voter-centric internet grassroots advocacy process from network log on to message delivery.

FIG. 2B illustrates an action alert page according to an embodiment.

FIG. 2C illustrates a form for receiving personal information from an advocate according to an embodiment.

FIG. 2D illustrates the results of a query showing an elected official according to an embodiment.

FIG. 2E illustrates a pre-written message according to an embodiment.

FIG. 2F illustrates a document addressed to an elected official according to an embodiment.

FIG. 2G illustrates a “thank you” message according to an embodiment.

FIG. 3A is a block diagram illustrating the grassroots advocacy targeting system from alert composition by grassroots coordinator to message delivery by advocate in accordance with another embodiment of the present invention.

FIG. 3B illustrates an exemplary query builder screen according to an embodiment.

FIG. 3C illustrates a form for composing an action alert according to an embodiment.

FIG. 3D illustrates a composed action alert page according to an embodiment.

FIG. 3E illustrates a fax version of the composed action alert page in FIG. 3D.

### DESCRIPTION OF THE PREFERRED EMBODIMENT

Techniques for facilitating political advocacy are described. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

### CONCEPTUAL OVERVIEW

In accordance with one aspect of the present invention, a system for political advocacy uses a nationwide voter registration database, rather than a zip code-to-district matching systems, to link advocates to their elected officials. Consequently, the problems with prior on-line political advocacy systems disappear.

First, the voter-centric system is extremely accurate. The elected official contact information that will be returned to the advocate will not rely on inaccurate map overlay techniques, as does the zip code based system. Instead, the voter-centric system references a voter's own data file, maintained by the state in which he resides. Besides personal information about that voter, this data file also contains the number-coded legislative districts assigned to that voter. With the use of this data file, the only other element needed to link a voter to his elected officials is an elected official database that contains an equivalent district code field (e.g., LA congressional district 6) as well as contact information (name, address, email, phone, fax). From these two elements (voter database and elected official database) an exact match can be found instantaneously.

Second, the voter-centric system reveals important information about the advocate to the elected official contacted. With the zip code based system, the elected official “knows” nothing about the person contacting him. Using such a zip code-based system, the official can only assume that the person (1) is a U.S. citizen, (2) lives in his legislative district, (3) is a registered voter in his district, and (4) votes regularly. However, with the voter-centric system he can tell at a glance that this person has been certified as (1) a U.S. citizen, (2) a person living in his district, (3) a registered voter in his district, and (4) a voter who voted X times in the last X elections. The relevance of the advocate contacting the elected official rises tremendously when the official can verify all of the above claims. Such verification will be based on statements made by a certifying authority. The certifying authority, in this case, would be the company marketing the voter-centric advocacy system and maintaining the secure Web site, through which the messages are sent.

Third, in order to trust the certifying authority, the elected official must know that the advocacy system is secure. There are many levels of security in today's marketplace, each sufficient for the level of risk involved in the transaction. High dollar bank-to-bank transfers need highly secure channels, while typical e-commerce credit card transactions need somewhat less security. The level of risk is dependent upon the potential payoff to the defrauder. Although the monetary payoff from grassroots advocacy communications is relatively small compared to bank-to-bank transactions, for interest groups desiring to influence legislation, the political payoff can be quite substantial. So, as a rule, it is important to discourage fraudulent communications with elected officials.

Although no system can be 100% secure, such a system becomes more secure when it erects hurdles that are either too cumbersome or too costly for a potential defrauder to work around. The voter-centric system proposed implements three independent levels of security each requiring that a separate piece of personal information be entered by the advocate: (1) voter name, (2) home address, and (3) voter's birth date. Further, all information exchanged between the client browser and the server can be encrypted in transfer using Secure Sockets Layer technology, and the final message can be sent to the elected official using Digital Signature technology. To defraud the system, the defrauder must have handy all of the three sources of information. The first two sources (voter name and home address) can all be easily found by searching the internet telephone directories, but they must be gathered one at a time and they cannot be searched by legislative district or even zip code (only by the individual's name). So to search this way would be very cumbersome. The third source of information, the voter's birth date, could be found in a voter database, as this is the source of the verification data. However, such a file would cost a significant amount of money to obtain, and this would not be an option for most people.

The final level of security, the digital signature and secure transaction levels, protects all activities processed through the voter-centric system from hackers who would break into the system and manipulate it from inside. Every step in the process can be protected by 128-bit encryption, which will deter even the most imaginative hackers.

Although no system is foolproof, the system described above will prove sufficiently cumbersome and costly to discourage a coordinated campaign of user fraud. Since grassroots advocacy affects public policy in America today, and its influence will surely grow in the near future, it is imperative that an elected official has a way to determine which messages are authentic and most relevant to him. The most advanced technology currently used (zip code-to-district matching technology) cannot provide this information to an elected official.

Further, the system as conceived can also provided targeted, focused communications to elected officials by using an advocate targeting tool. Such a system would work through a series of steps. First, a database containing grassroots advocate contact information (address, zip code, email, and fax) would be uploaded to the web site. Second, the grassroots coordinator for the interest group would open the targeting tool and designate which elected officials to focus grassroots pressure. Third, the system would try to find a match between the group's advocates and the targeted elected officials. Fourth, if any advocates are matched to the targeted officials, then the grassroots coordinator may create a special action alert and sample message to guide the advocate in sending his communication. Fifth, the action alert is sent to the advocate with a hyperlink that will take the advocate directly to the web site. And sixth, when the advocate goes to the web address specified in the action alert sent to him, he is directed to communicate to the elected official specified during the targeting session and is provided with the specific sample message provided during the targeting session. This process allows the grassroots coordinator of an organization to use a rifle-shot approach to grassroots advocacy rather than the current shotgun approach. With such a tool he can focus pressure exactly where and when he needs it.

So, the four problems in current grassroots advocacy technology: lack of accuracy, lack of relevance, lack of security, and lack of targeting capabilities can be ameliorated by moving from to this new technology.

### HARDWARE OVERVIEW

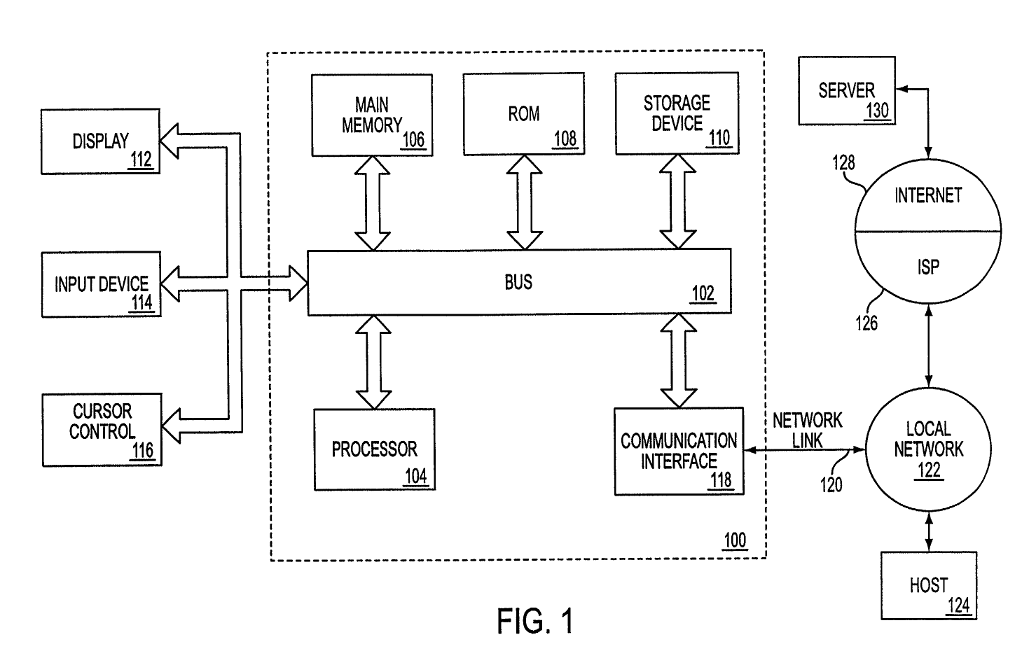

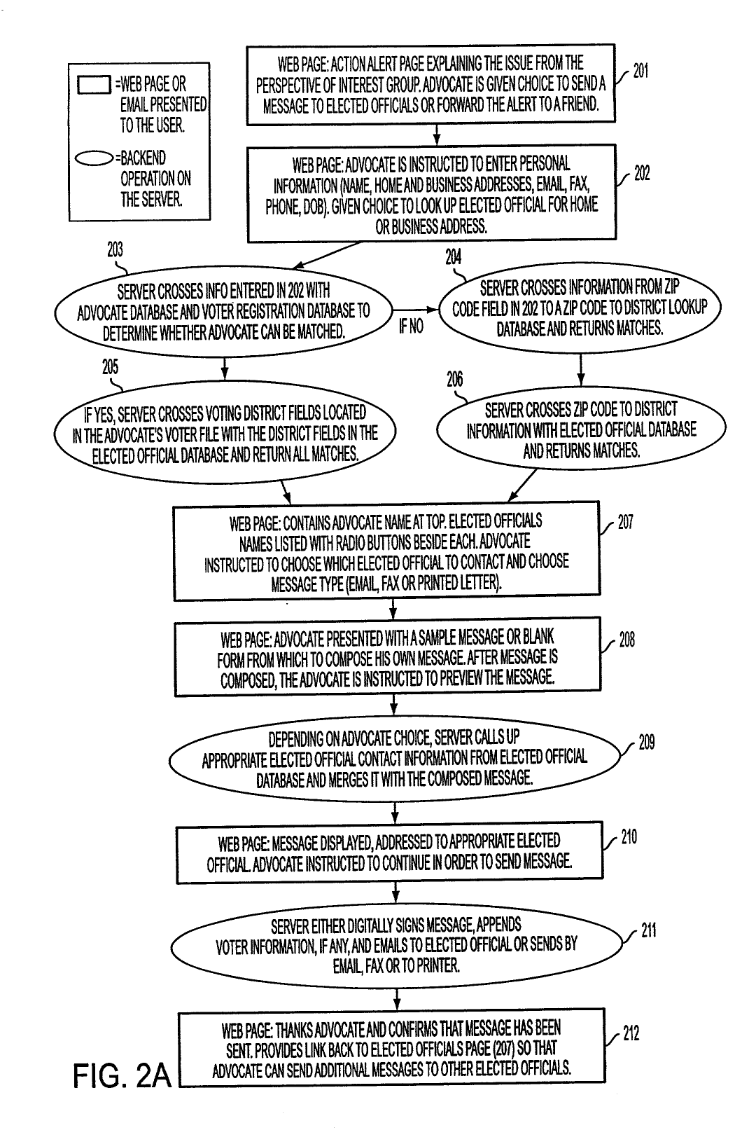

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

The invention is related to the use of computer system 100 for facilitating political advocacy. According to one embodiment of the invention, facilitating political advocacy is provided by computer system 100 in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. One or more processors in a multi-processing arrangement may also be employed to execute the sequences of instructions contained in main memory 106. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media include, for example, optical or magnetic disks, such as storage device 110. Volatile media include dynamic memory, such as main memory 106. Transmission media include coaxial cables, copper wire and fiber optics, including the wires that comprise bus 102. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be borne on a magnetic disk of a remote computer. The remote computer can load the instructions into its dynamic memory and send the instructions over a telephone line using a modem. A modem local to computer system 100 can receive the data on the telephone line and use an infrared transmitter to convert the data to an infrared signal. An infrared detector coupled to bus 102 can receive the data carried in the infrared signal and place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the worldwide packet data communication network, now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120, and communication interface 118. In the Internet example, a server 130 might transmit a requested code for an application program through Internet 128, ISP 126, local network 122 and communication interface 118. In accordance with the invention, one such downloaded application provides for facilitating political advocacy as described herein. The code may be executed by processor 104 as it is received, and/or stored in storage device 110, or other non-volatile storage for later execution. In this manner, computer system 100 may obtain application code in the form of a carrier wave.

### INDIVIDUAL POLITICAL ADVOCACY

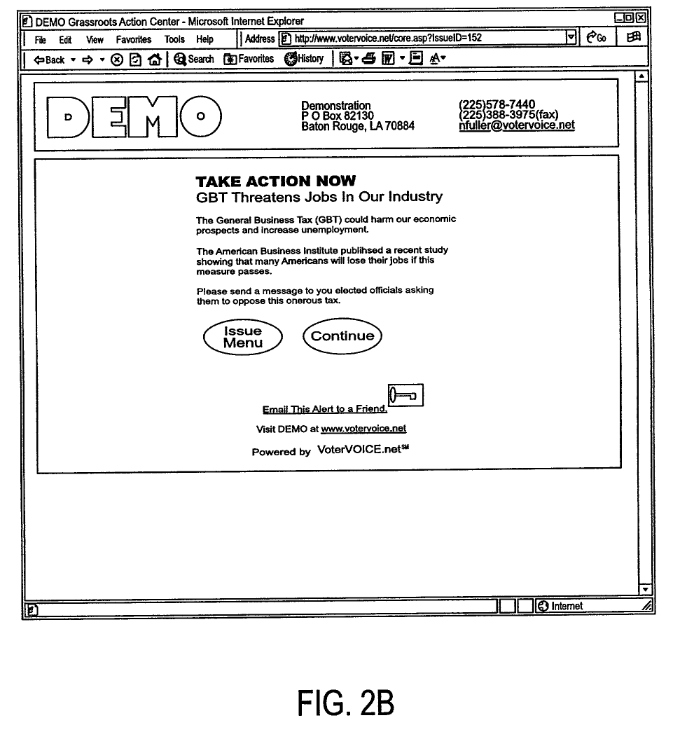

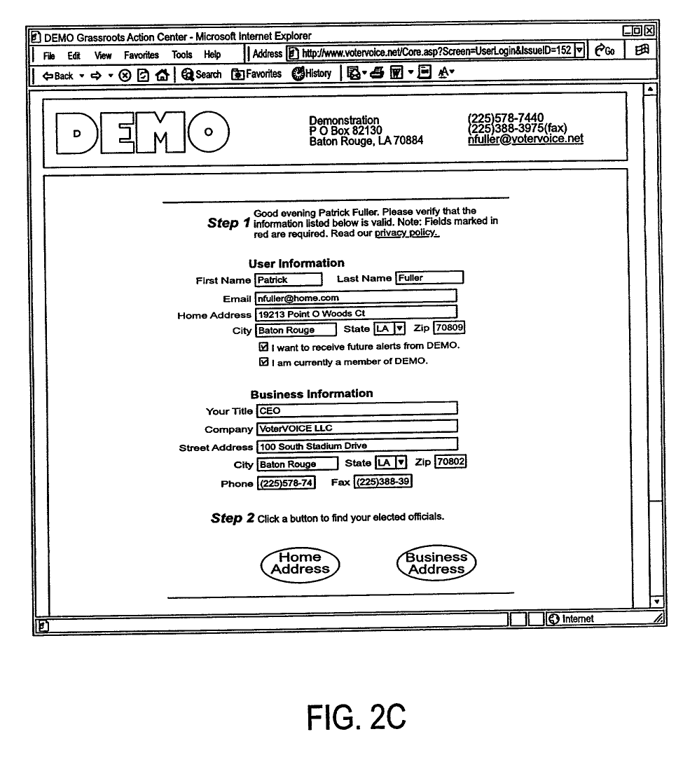

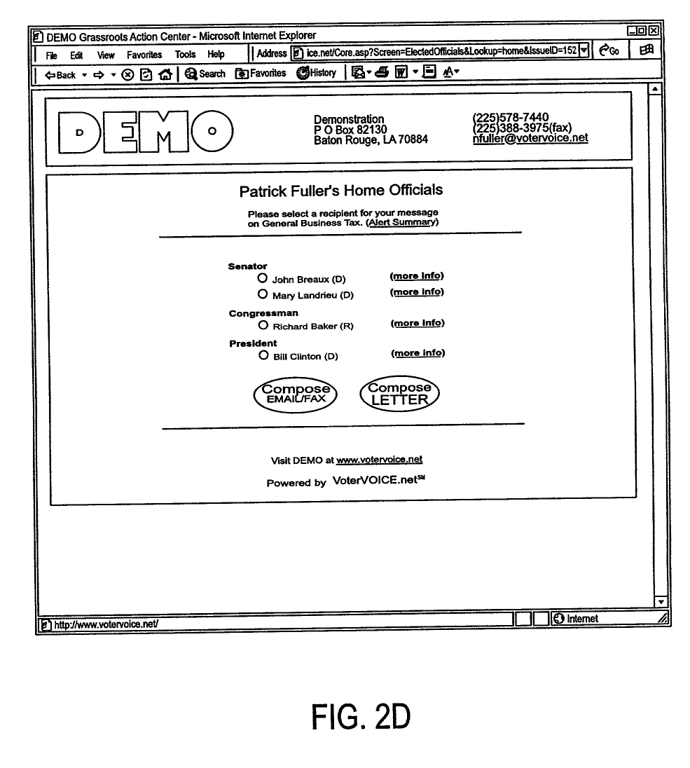

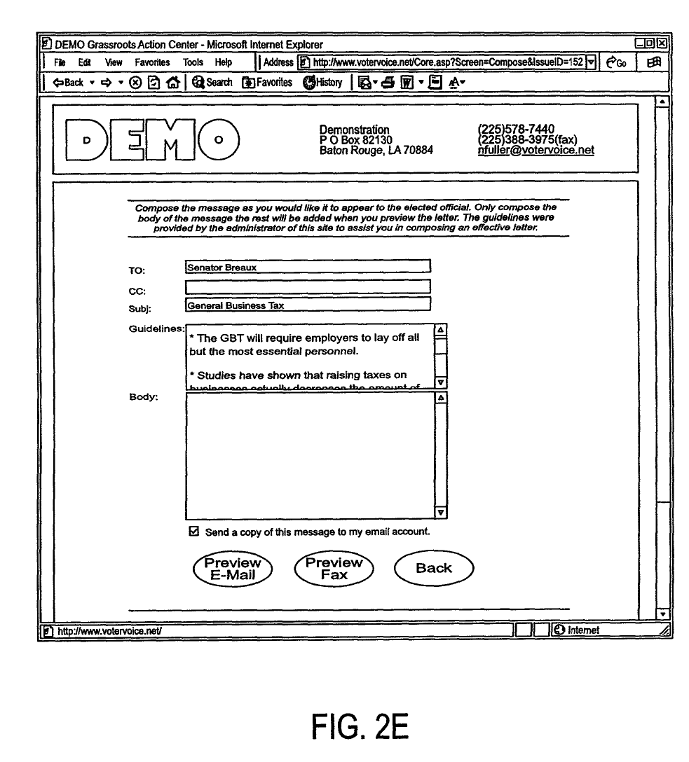

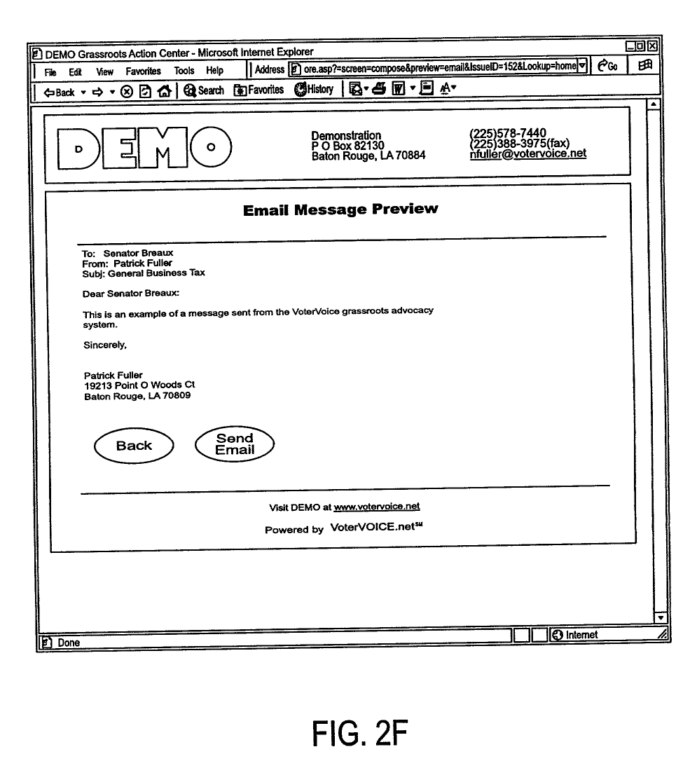

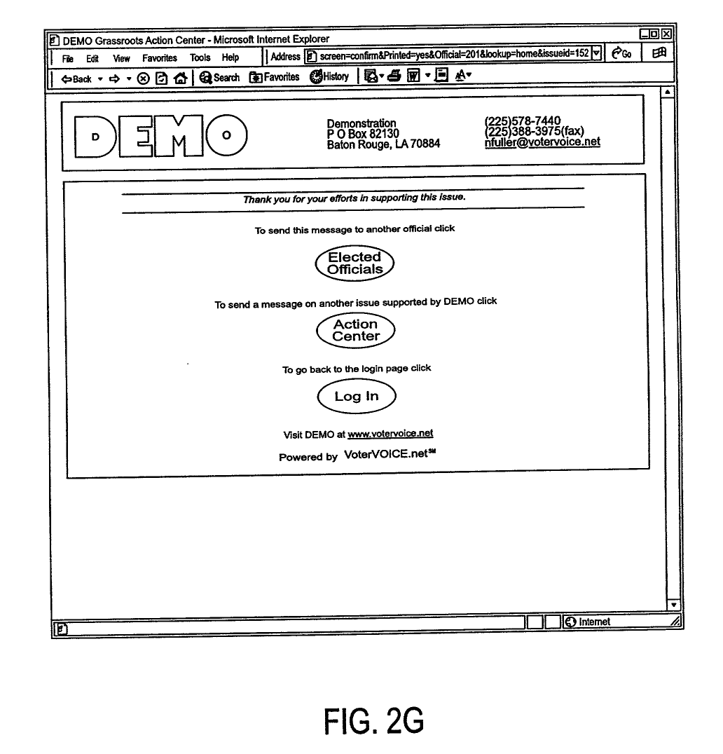

One embodiment of a method of grassroots advocacy using the Internet is implemented at a site on the World Wide Web, containing multiple pages within such site and multiple server-side database operations. The methodology is illustrated in FIG. 2A and examples of the multiple pages are show in FIGS. 2B, 2C, 2D, 2E, 2F, and 2G.

Referring to FIG. 2A, an individual advocate logs on to web site and the server displays an action alert page 201. An example an action alert page 201 created by the interest group leasing the site is illustrated in FIG. 2B. The action alert page 201 describes current issues that need the attention of members of that interest group and asks the person to send a message to his elected officials. Buttons at the bottom of the action alert page 201 allow the advocate to send a message to the advocate's elected officials or forward the alert to the email address of a friend.

Referring back to FIG. 2A, if the advocate choose to send a message, the advocate is then instructed to enter personal information into form provided (name, home and business address, email, fax, phone, DOB) and given the choice to look up elected official for home or business address (202). FIG. 2C shows an exemplary form, having input boxes for advocate name, home and business addresses, city, state, zip code, birth date, email address, phone, and fax. The advocate is prompted to fill in the form described above and to submit the information to the server for voter registration verification. This page (and all other pages described herein) can be protected by Secure Sockets Layer encryption to keep the process secure from start to finish.

After the advocate fills out the form and submits the personal information, the advocate's input data is crossed or matched with nationwide voter registration database to determine whether or not advocate is a registered voter (FIG. 2A, block 203). The voter registration data files are kept by state and county governments across the United States. These files could be bought from these primary government sources or from a variety of vendors, who combine the individual state and county lists into a consolidated database.

At block 205, if the advocate is verified as a registered voter according to voter database, the voting district fields located in the advocate's voter file is crossed or matched with the district fields in the elected official database and all the matches are returned.

FIG. 2D illustrates a results web page, displayed in block 207 of FIG. 2A, containing advocate information, elected official information, and message format choices. The return web page contains the results of the queries initiated upon submission of the queries submitted from page 202. The advocate's name appears at the top of the page, and below the advocate name is the elected official information (name and office held). Beside each elected official name is a radio button. Advocate is instructed to click one radio button in order to choose which elected official to send a message. Below the elected official information are buttons allowing the advocate to choose the type of message he wants to send (email/fax, printed letter).

If the advocate elects to send a message to the advocate's elected official, a web page 208 is displayed containing message composition materials. This page, which is illustrated in FIG. 2E, may contain a pre-written message that the interest group leasing the web site has provided or one blank message to be filled in by the user.

Depending on advocate choice, a contact number/address for the appropriate elected official is called up from an elected official database (block 209). A web page 210 is then displayed for the advocate having been formatted for type of message chosen, addressed to appropriate elected official, and composed with and appropriate pre-written message. Allow advocate to send email or fax or print from this screen (210). FIG. 2F illustrates one such page 210 showing a document formatted for the type of message chosen and addressed to the elected official chosen. The advocate is instructed to check the message for any errors. After checking for errors, advocate is instructed to click the SEND MESSAGE button at the bottom of the web page 210. Upon clicking the button, the message is either sent to the recipient or is sent to a printing device connected to the client computer.

In various embodiments, the web server can (1) digitally sign the message, certifying the authentic nature of the message or (2) send an unsigned message to the email inbox of the targeted elected official; and (3) send a copy to email address provided by the advocate. Printable letter is sent to printer connected to client computer (FIG. 2A, block 211).

The advocate is then displayed a web page 212 with a “thank you” message, an example of which is illustrated in FIG. 2G, and a confirmation that message was sent to the elected official targeted or that he has completed the process (for printed messages). The web page 212 allows the advocate to link back to the page 207 listing his elected officials, and start the process over again.

### TARGETED POLITICAL ADVOCACY

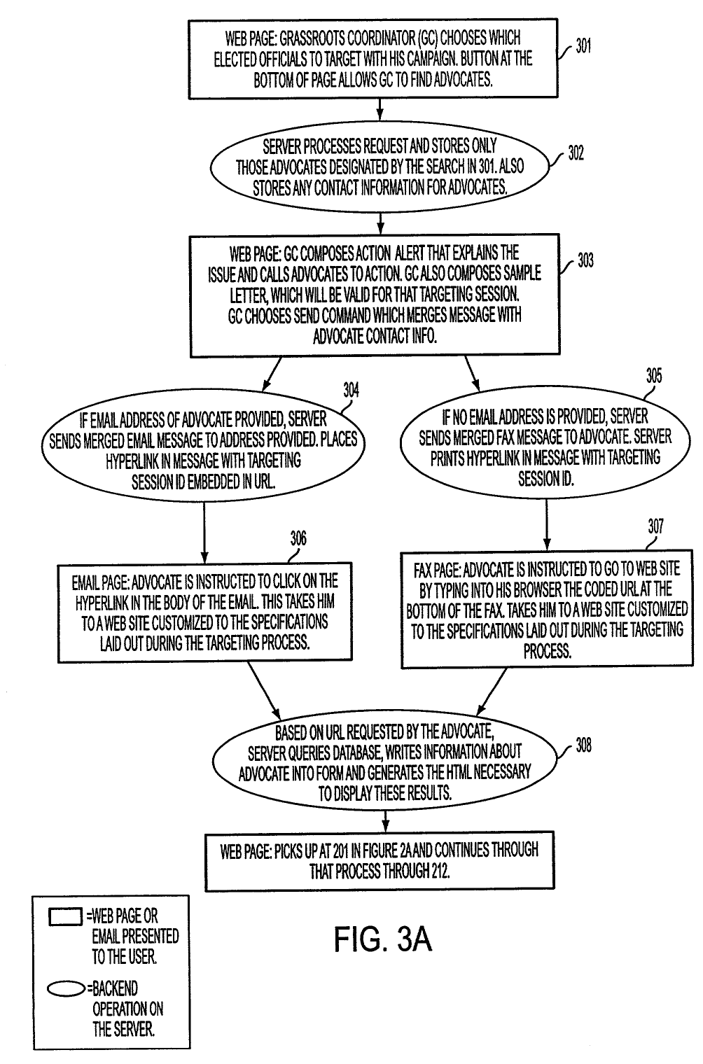

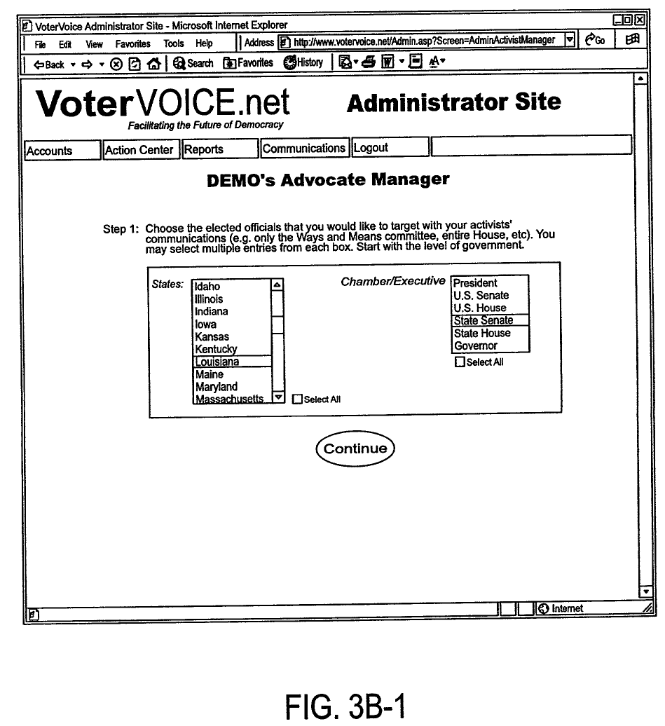

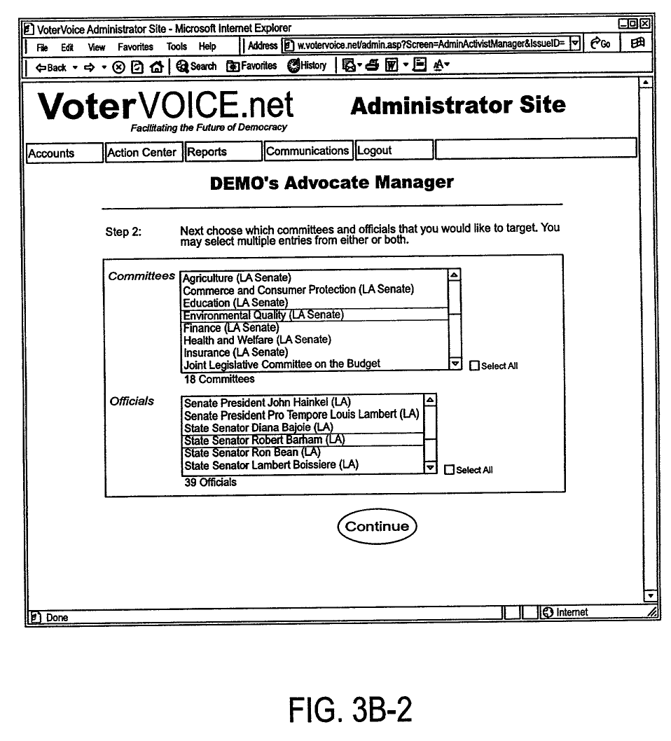

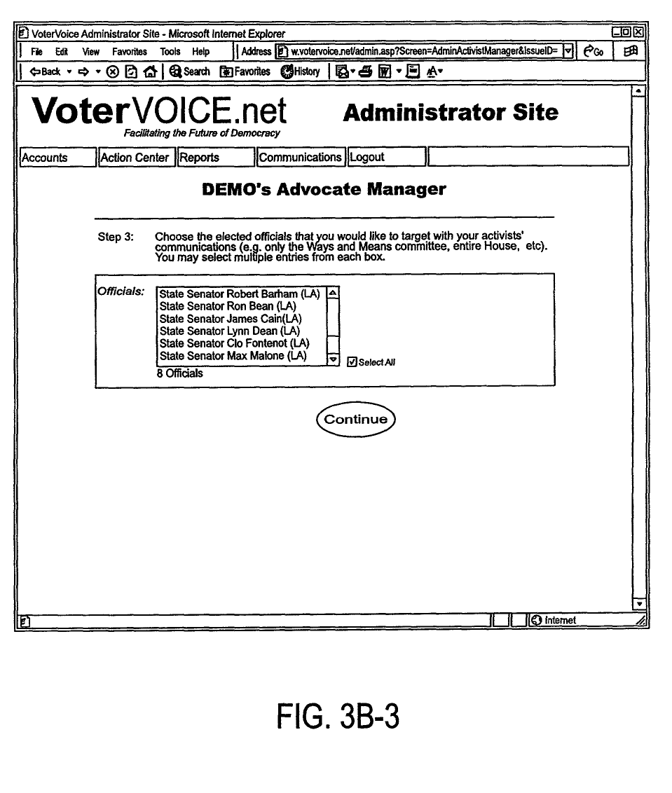

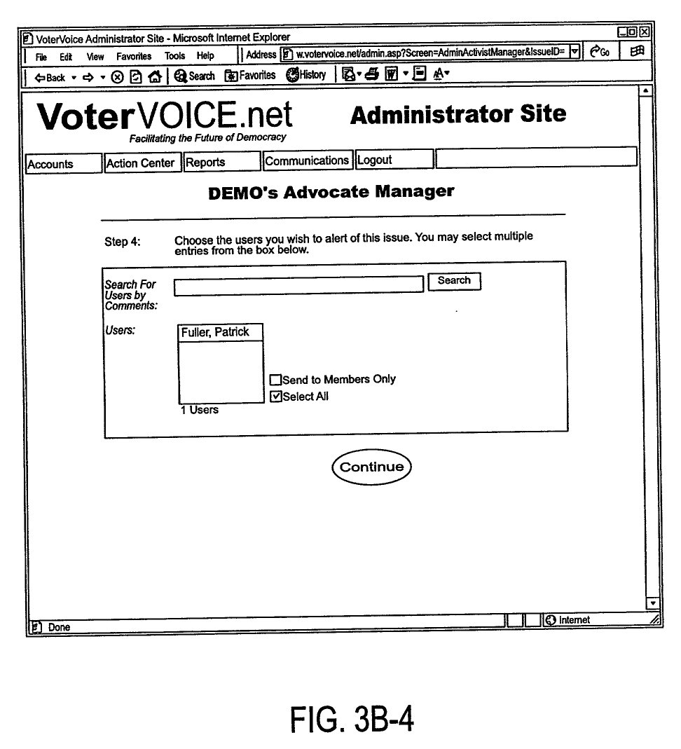

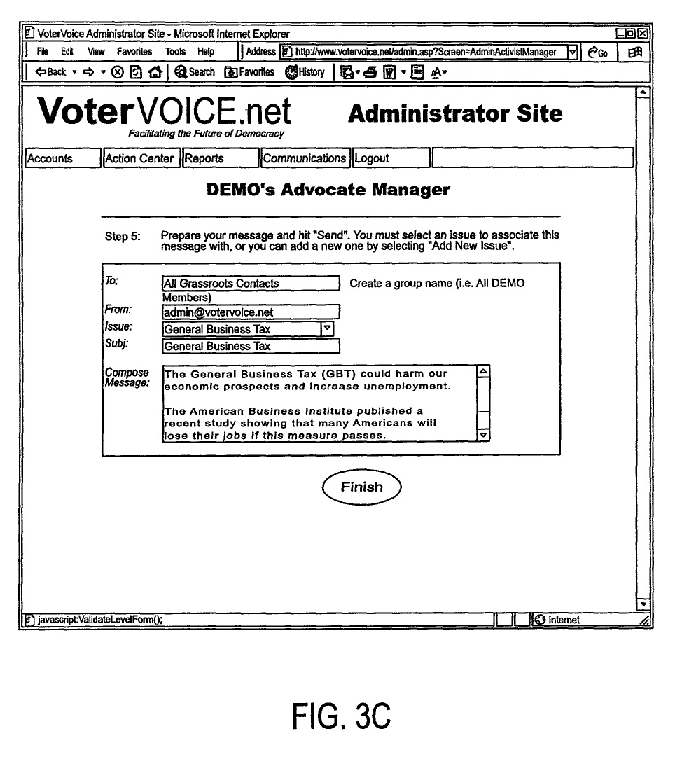

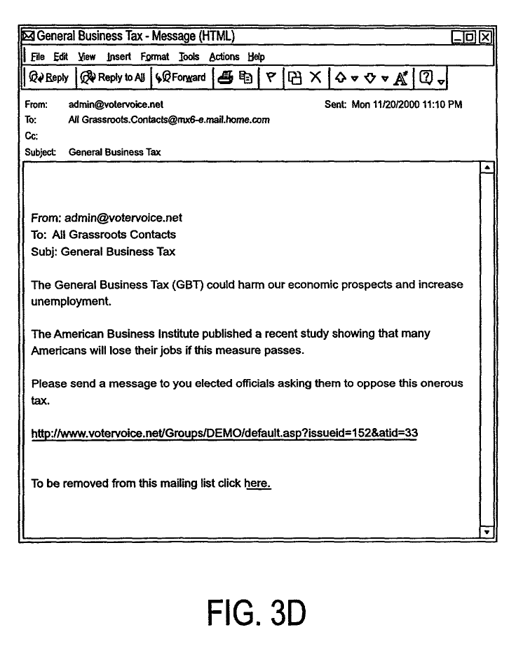

Another embodiment, directed to targeted political advocacy for a particular issue, is described with reference to FIG. 3A. At web page 301, a grassroots coordinator of the interest group using the web site may choose which elected officials to target with communications from advocates in the officials districts. A variety of different choices presented to the grassroots coordinator are contemplated but the present invention is not limited to any particular way of choosing the elected. For example, a form may allow the grassroots coordinator to select officials at the local, state or federal level; select officials by position such as president, vice president, senator, representative, governor, state senator, and state representative/delegate; and select officials by committee member (such as the House Energy Committee), by region (e.g. the South or Northeast), or by party (Democratic, Republican, Reform, Green, Libertarian, etc.) At the bottom of the page 301, a FIND ADVOCATES button allows the grassroots coordinator to identify those advocates who match the selected elected officials, for example, those advocates who are registered to vote in the officials' districts.

As illustrated in FIG. 3B, one example of the web page 301 includes a query builder screen, which enables the grassroots coordinator to choose which advocates the action alert message will be sent. The query may be based upon a previously uploaded database of potential advocates provided by the interest group, or the query may be based on advocates that have themselves signed on to the system. First, from the query screen, the grassroots coordinator chooses which elected officials to target and then submits the query to the database. The database returns only those advocates who have been previously matched to those targeted elected officials through the process shown in blocks 203-206 in FIG. 2A.

Referring back to FIG. 3A, the contact information for matched advocates is noted and then web page 303 is presented in which the grassroots coordinator composes an action alert that explains the issue and calls on the advocate to send a message to his elected officials. The grassroots coordinator may also choose to compose a sample letter specific to this issue, which will be displayed to the advocate when the advocate follows the hyperlink/web address automatically-generated from the advocate manager targeting session. Further, advocates will only see the targeted elected officials displayed on his ELECTED OFFICIAL page, and same advocates will only see the sample messages created for that specific targeting session. When the grassroots coordinator chooses the SEND command, the composed message is merged with advocate contact info.

Referring to FIG. 3C, the web page 303 allows the grassroots coordinator to compose an action alert that explains the political issue to the advocates and encourages the advocates to send a message to their elected officials. The grassroots coordinator is also given the opportunity to compose a sample message that will be tied to the ADVOCATE MANAGER SESSION in progress. When the grassroots coordinator chooses the SEND button at the bottom of the page, the information queried in 301 is merged with the message composed in 303 and sent to the addressed designated.

The web server then sends the merged message by the appropriate means. For example, if the merged message is an email message, then the web server sends the merged email message to an address of the advocate provided in advocate database. In this case, the web server places a hyperlink within the body of the email message (FIG. 3A, block 304), which if followed, takes the advocate to the action alert page. On the other hand, if the merged message is a fax message, the web server sends a merged fax message to the fax number provided in advocate database. Server prints the automatically-generated Web address in the body of the fax message (FIG. 3A, 305).

Upon receiving the email or fax message from the grassroots coordinator, the advocate is instructed to click on (for email message 304) or type into a web browser (for fax message 305) the web address present at the bottom of the action alert. This enables the advocate to return to a customized page on the web site, where the advocate's information is already populated in the form fields provided, by accessing the advocate database, and also with information only for targeted elected official. Furthermore, a special sample letter will be displayed. (306 or 307).

FIG. 3D illustrates an example of web page 306, delivered by email, which contains the message composed by the grassroots coordinator and instructs the advocate to click the hyperlink in the body of the message, which will take the advocate to a Web page on the site equivalent to 202 in FIG. 2. From there the advocate will continue the process through 213 as shown in FIG. 2. Similarly, FIG. 3E illustrates message 307, delivered by fax, which is equivalent to web page 306 in every other way except that the hyperlink in 306 becomes a typed address (URL), which the advocate must enter manually into his Web browser in order to enter the system.

When an advocate responds to the action alert by entering the web address into the browser. When the advocate responds, the advocate is taken to 202 in FIG. 2. Based on the web address supplied by the advocate, the server queries database, writes information about advocate into form and generates the HTML necessary to display these results (FIG. 3A, block 308). However, the major difference here is that the advocate will only see information designated by the grassroots coordinator in during the targeting session described above. This is made possible through the use of a targeting session ID, which is generated by the software and propagated through the system by the automatically-generated hyperlink/web address. The creation of this targeting session ID is the core element which enables this invention.

Accordingly, a web page is generated in the same fashion as 202 in FIG. 2 and process is continued through block 212. One difference between the process in FIG. 2 and the process described here is that only those points of information designated during the targeting session will be displayed to the advocate.

Thus, a method of facilitating political advocacy is described that addresses the primary inadequacies of the prior art: namely, non-relevant emails flooding the inboxes of elected officials, which dilutes the impact of other, more relevant grassroots advocacy messages. By linking to a nationwide voter registration database and providing a secure communication channel, the above described system can help an elected official identify, at a glance, whether the advocate communicating with him is who he says he is and whether he is a registered voter in that official's district. Interest groups are able to intensify their clout by proving that their communications are from voters who can influence the re-election of that elected official.

Democracy is a delicate institution. Its spirit must be continually replenished by the participation of its citizens in the governing process. Our nation's founders knew that a people disconnected from the process of public affairs will not for long abide as one people. Hence, it is imperative that we increase the level of trust and relevance in our communications with our elected officials and the institutions of representative government. The system described herein does this.

While this invention has been described in connection with what is presently considered to be the most practical and preferred embodiment, it is to be understood that the invention is not limited to the disclosed embodiment, but on the contrary, is intended to cover various modifications and equivalent arrangements included within the spirit and scope of the appended claims.

What is claimed is:

1. A method for facilitating political advocacy on-line, comprising the steps of:
receiving personal information that identifies an advocate;
accessing a voter database to retrieve voter information about the advocate based on the personal information; and
sending a message to a political official based on voter information.

2. The method according to claim 1, wherein the personal information includes a name and address of the advocate.

3. The method according to claim 2, wherein the personal information further includes a date of birth of the advocate.

4. The method according to claim 1, wherein the voter information includes whether or not the advocate is registered to vote.

5. The method according to claim 4, further comprising the step of composing the message to indicate whether or not the advocate is registered to vote.

6. The method according to claim 4, wherein the voter information includes a legislative district the voter is qualified to vote in.

7. The method according to claim 6, further comprising the step of composing the message to indicate the legislative district the voter is qualified to vote in.

8. The method according to claim 4, wherein the voter information further includes a voting history of the advocate.

9. The method according to claim 8, further comprising the step of composing the message to indicate the voting history of the advocate.

10. The method according to claim 1, further comprising the step of identifying the political official based on the voter information.

11. The method according to claim 1, further comprising the step of causing an action alert to be displayed to the advocate.

12. The method according to claim 1, further comprising digitally signing the message.

13. A web site for facilitating political advocacy, comprising:
means for receiving personal information that identifies an advocate;
means for accessing a voter database to retrieve voter information about the advocate based on the personal information; and
means for sending a message to a political official based on the voter information.

15. A computer-readable medium bearing instructions for facilitating political advocacy on-line, said instructions being arranged to cause one or more processors upon execution thereby to perform the steps of:
receiving personal information that identifies an advocate;
accessing a voter database to retrieve voter information about the advocate based on the personal information; and
sending a message to a political official based on the voter information.

15. A method for on-line targeted political advocacy, comprising the steps of:
receiving a selection targeting one or more political officials;
accessing an advocate database including voter information to identify one or more advocates that are registered to vote in a corresponding voting district of the one or more political officials; and
sending an action alert to the one or more identified advocates.

16. The method according to claim 15, further comprising the step of presenting a form allowing a grassroots coordinator to select the one or more political official.

17. The method according to claim 16, wherein the form permits the grassroots coordinator to select officials at a local, state, or federal level.

18. The method according to claim 16, wherein the form permits the grassroots coordinator to select officials by type of office, including president, senator, representative, governor, state senator, or state delegate.

19. The method according to claim 16, wherein the form permits the grassroots coordinator to select officials belonging to a specified legislative committee or caucus.

20. The method according to claim 15, further comprising the step of prompting a grassroots coordinator to compose the action alert.

21. The method according to claim 15, further comprising the step of embedding a hyperlink in the action alert, said hyperlink indicating a web site whereat an advocate can send a message to an elected official representing the advocate.

22. The method according to claim 15, wherein the step of sending the action alert includes sending the action alert by electronic mail.

23. The method according to claim 15, wherein the step of sending the action alert includes sending the action alert by facsimile.

24. A web site for on-line targeted political advocacy, comprising the steps of:
means for receiving a selection targeting one or more political officials;
means for accessing an advocate database including voter information to identify one or more advocates that are registered to vote in a corresponding voting district of the one or more political officials; and
means for sending an action alert to the one or more identified advocates.

25. A computer-readable medium bearing instructions for on-line targeted political advocacy, said instructions being arranged to cause one or more processors upon execution thereby to perform the steps of:
receiving a selection targeting one or more political officials;
accessing an advocate database including voter information to identify one or more advocates that are registered to vote in a corresponding voting district of the one or more political officials; and
sending an action alert to the one or more identified advocates.
